(19) United States
(12) Patent Application Publication
(10) Pub. No.: US 2007/0034118 A1
(43) Pub. Date: Feb. 15, 2007

(54) Dosage efficient, storage stable compositions for reducing chromium (VI) in cement

(76) Inventors: Leslie A. Jardine, Salem, MA (US); Charlotte Porteneuve, Boston, MA (US); Michael B. Macklin, Westford, MA (US); Michael S. Sumner, Gravesend (GB); Charles R. Cornman, Maynard, MA (US); Vijay Gupta, Woburn, MA (US)

Correspondence Address: Craig K. Leon, 62 Whittemore Ave., Cambridge, MA, 02140, US

(21) Appl. No.: 11/497,754

(22) Filed: Aug. 2, 2006

Related U.S. Application Data
(60) Provisional application No. 60/707,901, filed on Aug. 12, 2005.

(51) Int. Cl. C04B 7/32

(52) U.S. Cl. 106/693

(57) ABSTRACT

An association complex formed in a liquid environment from a metal-based chromium (VI) reducer and a non-lignosulfonate-based complexing agent is introduced into cement clinker or hydratable cement particles. In preferred embodiments, the formation of the association complex provides storage stability to the chromium reducer within the cement, such that the level of chromium (VI) after water is added to the cement remains less than 2 ppm for certain duration after mixing with water and without the necessity for further additions of chromium reducer during said duration (e.g., 26-84 or more days after addition). Compositions having the association complex are also described.

### FIELD OF THE INVENTION

The present invention relates to the use of reducing agents for hexavalent chromium (VI) in cement, and more particularly to the use of a non-lignosulfonate-based complexing agent for increasing the storage stability of a chromate (VI) reducing additive in hydratable cement particles, and particularly as a cement additive for combining with cement clinker before or during the intergrinding process used for manufacturing hydratable cement particles.

### BACKGROUND OF THE INVENTION

Chromium is an unavoidable trace element of the raw material used in the manufacture of cement clinker, which is ground to produce cement. In particular, hexavalent chromium (“chromium VI”) may form in the oxidizing and alkaline burning condition of the cement kiln. Chromium VI compounds are classified as extremely toxic because of their high oxidation potential and their ability to penetrate human tissue, thereby causing dermal sensitization, allergic reactions, and eczema. As chromium VI compounds have high solubility and are released when cement and water are mixed together, they tend to come into contact with human skin during the handling of wet cement and mortar. It is desirable therefore to reduce the amount of water-soluble hexavalent chromium to trivalent chromium form. This is because the trivalent form tends to precipitate from solution as a stable complex, thereby posing smaller risks as a serious dermal irritant. Indeed, a number of reducing agents are known. However, they tend to be effective at low pH levels rather than in the high pH environments of cementitious compositions.

Stannous (tin II) sulfate can be employed as a chromium (VI) reducer for cement. Although stannous sulfate is water soluble, it quickly loses dosage efficiency over time when added as an aqueous solution into cement. The actual amount of stannous sulfate in solution is at least double the amount that is required over time when stannous sulfate is added as a powder, because upon addition to the cement the solubilized stannous sulfate has a very high surface area that increases its susceptibility to oxidation. Such a disparity often precludes the use of stannous sulfate in solution form as a matter of economics.

In Ser. No. 10/890,476 filed Jul. 13, 2004, Jardine et al. disclosed the use of aqueous dispersions containing solid tin sulfate particles that were substantially uniformly dispersed within the liquid carrier at high levels by using one or more viscosity modifying agents. The principle underlying the use of the liquid aqueous dispersions was to achieve high loading of the particles, such that the tin sulfate would be present both as a dispersed solid as well as a solubilized component. The use of the liquid also provided a greater advantage in terms of environmental health and safety by eliminating the opportunity for human inhalation of chemical dust. Moreover, the liquid carrier provides dosage accuracy and efficiency because the stannous sulfate can be pumped and metered at the same time.

The present invention concerns similar objectives in that it focuses upon improving the efficacy of chromium (VI) reducing additive that can be used, and in addition increases the storage stability of this additive in a manner that is economic and convenient. The present invention is also believed to be particularly suitable for meeting new legislative objectives in European Union countries regarding such chromium (VI) reducing additives.

For example, on Jan. 17, 2005, legislation known as the Chromium (VI) Directive (2003/53/EC) was implemented in the European Union, and applied to cement and cement-containing preparations. This legislation is intended to minimize the occurrence of chromate-related allergic dermatitis arising from the use of cement. To meet these requirements, it is necessary to control the amount of soluble chromium (VI) in all bulk and bagged cements by the addition, where necessary, of small amounts of a reducing agent, such as ferrous sulfate or stannous sulfate. In the European Union, it was suggested that cements should have levels of soluble chromium (VI), when water is added to the cement, that have no more than 2 ppm (0.0002%) by mass of the dry cement.

For the cement manufacturing industry, these objectives may appear rather optimistic given the harshness of the cement milling environment, in which temperature, air, and moisture conditions can undermine the efficacy of chromium reducing agents. Most of the energy that is required by the grinding of cement clinker to produce cement appears in the form of heat, which results in a rise in temperature of the material leaving the mill. Such high milling temperatures result in a decrease of grinding efficiency, because the cement particles have an increased tendency to agglomerate. All mills have some cooling by the use of forced airflow through the mill, and some have additional water injection for cooling as well. The cement is normally transported using air or screw systems that allow individual cement particles to come into contact with air. Thereafter, the cement product is placed into paper bags, which for the most part are not moisture impermeable, or into storage silos, which for the most part are not air or moisture impermeable. Thus, the manufacture of cement involves extreme temperature, air, and moisture conditions which work to the detriment of chromium reducing agents both during manufacture and storage of the cement product.

In view of these harsh conditions in the cement mill, chromium reducing agents, such as ferrous sulfate or stannous sulfate, which are added to the cement during production, have limited periods during which they remain effective. After expiration of this period (also called “shelf life”), such chromium reducing agents can no longer be relied upon to keep the soluble chromium (VI) below 2 parts per million (ppm) when the cement comes into contact with water. Thus, prior art methods require massive initial dosages of the chromium reducer, or periodic re-dosing to ensure low levels of chromium (VI) in the cement, thereby increasing costs.

The present inventors believe that novel methods and compositions are needed for achieving storage stability of a chromium (VI) reducing agent in cement, during and after the manufacture of the cement, so that the chromium (VI) reducing agent can be relied upon to maintain chromium (VI) levels below 2 ppm, even when the cement comes into contact with water several months after the chromium (VI) reducing agent has been introduced to the hydratable cement.

### SUMMARY OF THE INVENTION

In surmounting the disadvantages of prior art chromium (VI) reducing methods for cement, the present invention provides novel methods and compositions for maintaining the efficacy of chromium reducers in cement over time. A chromium (VI) reducer, such as stannous (tin II) sulfate, is combined with a non-lignosulfonate-based complexing agent, such as sodium gluconate, to form a molecular association or coordination compound (hereinafter referred to as an “association complex”) before introducing the chromium reducer to hydratable cement, thereby stabilizing the chromium (VI) reducer in the hydratable cement during storage, such that when the cement is eventually mixed with water to initiate hydration thereof, the chromium (VI) reducer remains active for reducing water-soluble chromium VI to chromium III.

The association complex can be used in the form of a concrete or masonry admixture, which is intended to be added to hydratable cement binder before, during, or after mixing the hydratable cement with water.

The association complex may be used in the form of a liquid (preferably aqueous) or a dried form (e.g., particles), although the aqueous liquid form is preferred for purposes of convenience. The amount of association complex should preferably be 10-100%, and more preferably 20-100%, based on total weight of the composition.

More preferably, the association complex is added as a cement additive to cement clinker before or during the manufacturing process whereby the clinker is interground into hydratable cement particles. Particularly in this latter case, the inventors discovered that by forming the association complex first (e.g., stannous gluconate or stannous gluconic acid), and then combining this with cement clinker before or during the intergrinding process, the resultant cement particles will have lower levels of chromium (VI) after several months of storage, when compared to a process wherein the chromium reducer is not used with such a non-lignosulfonate-based complexing agent, because the chromium (VI) reducing agent is maintained in an effective state by the use of the association complex. The association complex may be added to the cement after the manufacturing process.

This means that methods and compositions of the invention offer cost savings to cement manufacturers as well as to concrete producers, because they do not need to use high initial dosages or to keep re-dosing the same cement over time in order to maintain minimum acceptable levels of chromium (VI) in their cement product.

Preferred association complexes of the invention are made by combining stannous (tin II) sulfate and sodium gluconate in an aqueous environment to form a “stannous sulfate/sodium gluconate association complex.” This term not only refers to the association of stannous ions with the gluconic acid ligands in water, example, but also to the fact that this association is made by combining stannous sulfate with sodium gluconate. As will be discussed later in this specification, the “stannous sulfate/sodium gluconate association complex” has a different Nuclear Magnetic Resonance characteristic than a “stannous chloride/sodium gluconate association complex” formed by combining stannous chloride with sodium gluconate, even though both of these association complexes both involve the formation stannous gluconic acid. The inventors discovered that the “stannous sulfate/sodium gluconate association complex” appears to provide better stability in terms of the ability of the tin to reduce chromium (VI) when compared to the “stannous chloride/sodium gluconate association complex.” Hence, the inventors believe it is desirable to use the full names of the starting components to describe their most preferred form of “tin gluconic acid” association complex.

Exemplary methods of the invention comprise: introducing to cement clinker or to hydratable cement particles a liquid composition having therein an association complex formed from a metal-based chromium (VI) reducer and a non-lignosulfonate-based complexing agent. Preferably, the association complex within the liquid environment is added to cement clinker, preferably before or during the intergrinding process used to manufacture hydratable cement particles.

In an exemplary method of the invention, a metal-based chromium (VI) reducer, in the association complex formed using a non-lignosulfonate-based complexing agent, is combined with cement clinker (or added to hydratable cement particles) in an amount of 20-5000, and more preferably 30-2000, and most preferably 40-400 parts per million (ppm) of chromium reducer for each 5 ppm of chromium (VI) contained in the cement clinker or hydratable cement particles. Subsequently, the clinker is interground to produce hydratable cement particles having the complexed chromium (VI) reducer. Through this exemplary method, the resultant hydratable cement particles of the invention can have an average level of chromium (VI) which is less than 2 parts per million by weight of cement without further additions of a chromium (VI) reducer, during the successive 26 days after intergrinding, more preferably during the successive 56 days after intergrinding, and most preferably during the successive 84 days after intergrinding.

In forming the association complexes of the invention, the inventors prefer to combine chromium (VI) reducing metal salts, such stannous (tin II) sulfate, iron sulfate, iron acetate, etc., and the like, with non-lignosulfonate-based complexing agents such as sodium gluconate, although they believe that other non-lignosulfonate-based complexing agents can be selected from carboxylic acids, polyhydroxy alcohols, or salts thereof. The non-lignosulfonate-based otherwise attach to the metal salt to minimize or to prevent precipitation or oxidation, and this in turn is believed to maintain the chromium (VI) reducer in an effective state when the treated cement is later combined with water to initiate cement hydration.

In exemplary methods and compositions of the invention, therefore, the metal-based chromium (VI) reducer, combined with a non-lignosulfonate-based complexing agent to form the association complex, is combined with cement clinker or hydratable cement particles in an amount of 20-5000, and more preferably 30-2000 parts per million (ppm) of the chromium reducer for each 5 ppm of chromium (VI) contained in the cement clinker or hydratable cement particles.

A further exemplary cement additive or concrete/masonry admixture liquid composition of the invention thus comprises, in addition to water, a chromium (VI) reducer (e.g., stannous sulfate) and a complexing agent (e.g., sodium gluconate) which are both in an amount of at least 1.0% to 90% by weight based on total mass of the liquid composition, and an optional viscosity modifying agent, cement additive, or a mixture thereof.

An exemplary liquid composition of the invention comprises: an association complex in a liquid (e.g., aqueous) environment, said association complex formed by combining a metal-based chromium (VI) reducer and a non-lignosulfonate-based complexing agent, said association complex being present in an amount of at least 10%-100%, and more preferably 20%-80% based on total weight of said liquid composition.

In a preferred method of the invention, a stannous gluconic acid (or salt) is introduced into cement clinker before or during the intergrinding process used for manufacturing hydratable cement particles, or directly introduced into the cement particles.

It is believed that solid particles comprising association complexes of the present invention, such as the preferred stannous sulfate/sodium gluconate association complexes, may be used, in addition to liquid compositions containing such association complexes.

In preferred embodiments of the invention, a stannous sulfate/sodium gluconate association complex (which includes stannous gluconic acid) is formed by combining stannous sulfate with sodium gluconate in a stannous sulfate: sodium gluconate molar ratio of 4:1 to 1:4, and most preferably in a ratio of 1:2 to 2:1, with a 1:1 molar ratio being most preferred.

Further advantages and features of the invention are described in further detail hereinafter.

### BRIEF DESCRIPTION OF DRAWINGS

FIG. 1 is a graphic illustration of chromium (VI) content in parts per million (ppm) cement measured over time (age in terms of days storage time) of various cement samples, including an exemplary embodiment of the invention, wherein cement is interground with a stannous sulfate/sodium gluconate association complex in accordance with the present invention (See Examples 1-3);

FIG. 2 is a graphic illustration of chromium content in parts per million (ppm) cement measured over the age (in days storage) of various cement samples, including an exemplary embodiment of the invention wherein cement is interground with a stannous sulfate/sodium gluconate association complex in accordance with the present invention (See Examples 4-6);

FIG. 3 is a graphic illustration of the chromium (VI) content of a cement interground with a stannous sulfate/sodium gluconate association complex in accordance with the present invention, based on data contained in Table 7, and the chromium (VI) content of a cement interground using a 56% tin sulfate suspension (PRIOR ART, not having the association complex) based on data contained in Table 8;

FIG. 4 is a graphic illustration of various ¹¹⁹Sn Nuclear Magnetic Resonance spectra (¹¹⁹Sn NMR): (A) stannous sulfate alone; (B) stannous sulfate/sodium gluconate association complex of the present invention; (C) another stannous sulfate/sodium gluconate association complex of the present invention and (D) stannous chloride: sodium gluconate association complex of the present invention;

FIG. 5 is a graphic illustration of a ¹³C Nuclear Magnetic Resonance spectrum of (A) stannous sulfate/sodium gluconate association complex of the present invention depicting a downfield shift in the resonance for carbon 1 (¹C) as can be seen in comparison to a ¹³C Nuclear Magnetic Resonance spectrum of (B) sodium gluconate alone; and

FIG. 6 is a graphic illustration of an ¹H Nuclear Magnetic Resonance spectrum of stannous sulfate/sodium gluconate association complex of the present invention wherein said stannous sulfate and sodium gluconate were combined in an aqueous composition in a preferred 1:1 ratio.

### DETAILED DESCRIPTION OF EXEMPLARY EMBODIMENTS

The term “cement” as used herein means and refers to Portland cement, which, as used in the construction trade, means a hydratable cement produced by pulverizing or intergrinding cement clinker which consists of calcium silicates usually containing one or more of the forms of calcium sulfate as an interground addition with ASTM types I, II, III, IV, or V (or other types such as EN197). “Cementitious” materials are materials that alone have hydraulic or hydratable cementing properties in that they set and harden in the presence of water. Included in cementitious materials are ground granulated blast-furnace slag (although some air cooled slags may be deemed cementitious as well) and natural cement (e.g., ordinary Portland cement). “Cementitious” materials may also include gypsum (e.g., calcium sulfate hemihydrate), aluminous cement, ceramic cement, oil well drilling cement, and others.

The term “cement,” as used in the present invention, may include pozzolans, which are siliceous or aluminosiliceous materials that possess little or no cementitious value (i.e., as a binder) but which will, in finely divided form in the presence of water, chemically react with the calcium hydroxide released by the hydration of Portland cement to form materials with cementitious properties. See e.g., Dodson, V., Concrete Admixtures (Van Nostrand Reinhold, New York 1990), page 159. Diatomaceous earth, limestone, clay (e.g., metakaolin), shale, fly ash, silica fume, and blast furnace slag are some of the known pozzolans. Certain ground granulated blast-furnace slags and high calcium fly ashes possess both pozzolanic and cementitious properties.

In methods of the invention wherein clinker is ground to produce cement, it is believed that any of the known grinding mill types may be employed, including ball mills and roll (or roller) mills. Mills having rolls (such as roll press mills) can be used wherein the cement clinker (or slag or fly ash) are crushed on circular tables upon which rollers are revolved. Other types of roller mills employ two or more rollers that are nipped together, and clinker or other cement, or cementitious precursors, are crushed by dropping materials vertically between nipped rollers. Thus, the methods and compositions of the invention can be used in both ball mills and roller mills that are used for grinding precursor materials (e.g., clinker) to produce hydratable cement particles.

The present inventors have discovered how to maintain the storage stability of a chromium (VI) reducing additive that is interground with clinker into hydratable cement. This is accomplished by first combining stannous (tin II) ions and a non-lignosulfonate-based complexing agent to form a molecular association or coordination compound within a liquid environment (which is preferably aqueous); and thereafter introducing this “association complex” comprising the complexed stannous (tin II)/complexing agent to the cement clinker, before and/or during the grinding of the clinker to produce the hydratable cement particles.

The terms “association,” “complex,” and “association complex” may be used interchangeably herein to refer to a bonding between the tin salt and/or ions and the non-lignosulfonate-based complexing agent or agents. This bonding is believed to be neither covalent nor merely electrostatic in nature, but intermediate between these two types.

The term “association” as used herein is consistent with a standard dictionary definition. According to Hawley's Condensed Chemical Dictionary (11^{th} edition), the term “association” means “a reversible chemical combination due to any of the weaker classes of chemical bonding forces.” The term “association” can mean and refer to “the combination of two or more molecules due to hydrogen bonding as in the union of water molecules with one another or of acetic acid molecules with water molecules is called association,” and also to a “combination of water or solvent molecules with molecules of solute or with ions, i.e., hydrate formation or solvation.” The term “assocation” may also include “[f]ormation of complex ions or chelates [such] as copper ion with ammonia or copper ion with 8-hydroxy-quinoline . . . [as] other examples.” See e.g., Hawley's Condensed Chemical Dictionary (11^{th} edition), revised by N. Irving Sax and Richard J. Lewis, Sr. (Van Nostrand Reinhold Company, Inc., New York 1987), page 103.

Also appropriate to the description of the compound formed by stannous ions and complexing agents is the term “coordination compound,” which is synonomous with the term “complex compound,” and which is defined in Hawley's Condensed Chemical Dictionary (11^{th} edition) as “a compound formed by the union of a metal ion (usually a transition metal) with a nonmetallic ion or molecule called a ligand or complexing agent.” Hawley's Dictionary also explains that “[a]ll ligands have electron pairs on the coordinating atom . . . that can be either donated to or shared with the metal ions.” Hawley's Dictionary also explains that “the metal ion acts as a Lewis acid (electron acceptor) and the ligand as a Lewis base (electron donor),” and thus the “bonding is neither covalent nor electrostatic but may be considered intermediate between the two types.” See Hawley's Condensed Chemical Dictionary (11^{th} edition), Id. at page 307.

Thus, the present inventors prefer the term “association complex” to describe the compound formed by combining a metal capable of reducing chromium (VI), such as tin (II), with a non-lignosulfonate-based complexing agent to protect the chromium reducing ability of the metal during and after it is combined and interground with cement clinker to produce hydratable cement particles.

Without being bound by theory, the present inventors believe that the “association complex” formed between a metal such as tin (II) and a complexing agent is similar or identical to “chelate” compounds in which a metal ion is attached by coordinate links to two or more nonmetal atoms in the same molecule referred to as ligands, thereby forming one or more heterocyclic rings with the metal atom. See “chelate” definition, Hawley's Dictionary, Id. at page 249).

The term “complexing agent” as used in this invention means and includes ligands, chelates, and/or chelating agents that are operative to form association complexes with metal-based chromium (VI) reducing agents such as stannous and/or ferrous (II) ions and/or salt forms thereof.

The term “non-lignosulfonate-based,” as used in herein to describe complexing agents which combine with the metal-based chromium (VI) reducing agents, means and refers to complexing agents that are not lignosulfonate or derivatives thereof. Lignosulfonates are derived from manufacturing processes used for pulping paper. A lignosulfonate derivative, for example, is described in World Patent Application No. WO 99/37593 of Chemische Werke Zell-Wildshausen GmbH, and is used for reducing chromium in concrete compositions. The present inventors do not desire to employ lignosulfonates or lignosulfonate-derived molecules as complexing agents due to the random structures of lignosulfonates and the unpredictable effect that such random molecules can have when used in cementitious compositions. Moreover, lignosulfonates tend to have high levels of impurities that can also cause unpredictable effects, such as excessive retardation, when used in cementitious compositions.

The present invention therefore concerns methods and compositions for manufacturing cement from cement clinker, by which a non-lignosulfonate-based complexing agent is used to form an association complex with a metal-based chromium (VI) reducer (e.g., stannous (tin II) ions, ferrous ions, manganese ions) in an aqueous liquid carrier, and then this association complex formed in the liquid carrier is introduced into the intergrinding process wherein clinker is converted into hydratable cement particles.

A preferred non-lignosulfonate-based complexing agent of the present invention is a gluconic acid or salt thereof, such as sodium gluconate. The term “gluconate” as used herein in aqueous environments may also include the gluconic acid form, and thus these two terms may be used interchangeably herein. Other exemplary complexing agents may include monocarboxylic acids or salts thereof (represented by the formula HOCH₂(CHOH)ₙCOOH wherein “n” is an integer of 3-8 and more preferably 4 (and this includes gluconic acid, xylonic acid, etc.)); dicarboxylic acids or salts thereof (represented by the formula HOOC(CHOH)ₙCOOH wherein “n” is an integer of 3-8 and more preferably 4 (and this includes glucaric which is also known as saccharic acid)); polyhydroxy alcohols or salts thereof (represented by the formula HOCH₂(CHOH)ₙCH₂OH wherein “n” is an integer of 3-8 and more preferably 4 (and this includes glycitol which is also known as sorbitol)); and aldyehydo acids and or salts thereof (represented by the formula HOOC(CHOH)ₙCHO wherein “n” is an integer of 3-8 and more preferably 4 (and this includes glucuronic acid)).

The present inventors believe that conventional chelating agents may also be used as non-lignosulfonate-based complexing agents in methods and compositions of the present invention. Such chelating agents include:

ethylenediaminetetraacetic acid (EDTA);

mitrilotriacetic acid (N(CH₂COOH)₃; and

ethyleneglycol-bis(B-aminoethyl ether)-N,N-tetraacetic acid, which may be represented by the following formula
(NOOCCH₂)₂NCH₂CH₂OCH₂CH₂OCH₂CH₂N(CH₂COOH)₂.

Other exemplary non-lignosulfonate-based chelating agents include ethylene glycol, glycerine, glucose, dextrose, and sucrose. The formation of a chelate is based on a 2 to 6 carbon atom structure having numerous hydroxyl groups. Hydroxyl groups should preferably be on adjacent carbon atoms. This allows for chelation of tin in a 5-member ring.

Additional exemplary non-lignosulfonate-based complexing agents or chelating agents for tin include: polyvinyl alcohol, tripolyphosphates, copolymers of vinyl methyl ether, and maleic anhydride, N-benzoyl-N-phenylhydroxylamine, acetylacetone, benzoylacetone, dibenzoylmethane, salicylaldehyde, 8-hydroxyhydroquinone, and 8-quinolinol.

The present inventors believe that suitable association complexes useful for the purposes of the present invention may also be found in U.S. Pat. No. 6,872,300 of Galperin, which discloses, for use in reforming catalyst applications certain tin compounds that form complexes with specific chelating ligands. The present inventors thus incorporate into their application the tin compounds mentioned by Galperin at column 7, lines 2-33, wherein Galperin describes an aqueous solution of a chelating ligand and at least one soluble, decomposable metal promoter compound “prepared to give a promoter metal chelate complex.” Thus, suitable examples of tin for purposes of the present invention include, without limitation, stannous bromide, stannous chloride, stannic chloride, stannic chloride pentahydrate, stannic chloride tetrahydrate, stannic chloride trihydrate, stannic chloride diamine, stannic trichloride bromide, stannic chromate, stannous fluoride, stannic fluoride, stannic iodide, stannic sulfate, stannic tartrate, stannic oxalate, stannic acetate and the like compounds. (The utilization of a tin salt in the form of a chloride compound, such as stannous or stannic chloride can be used to facilitate the incorporation of both the tin component and at least a minor amount of a halogen component in a single step.) Galperin describes a salt with tin having a plus two (+2) oxidation state.

Galperin also describes chelating ligands which are believed to form chelating complexes with the foregoing tin compounds, and these the present inventors also believe are suitable in the present invention for combination with these and other metal-based chromium (VI) reducers suitable for use in the present invention. Exemplary chelating ligands thus include amino acids. Specific examples of these amino acids include ethylenediaminetetraacetic acid, nitrilotriacetic acid, N-methylaminodiacetic acid, iminodiacetic acid, glycine, alanine, sarcosine, alpha-aminoisobutyric acid, N,N-dimethylglycine, alpha,beta-diaminopropionate, aspartate, glutamate, histidine, and methionine. See U.S. Pat. No. 6,872,300B1 at column 7, lines 18-26. Galperin mentions that the chelate-metal complex solution (which could include the chelate-tin complex solution) can be heated for a time of about 5 minutes to about 5 hours at a temperature of about 40 degrees Celcius to about 100 degrees Celcius or its boiling point. The ratio of chelating ligand to the metal salt will vary from about 1 to about 8 and preferably from about 1.5 to about 4. U.S. Pat. No. 6,872,300B1 at column 7, lines 27-32.

Exemplary non-lignosulfonate-based complexing agents are preferably added to cement in the amount of 0.00005-0.2%, more preferably in the amount of 0.0005-0.10%, and most preferably in the amount of 0.001-0.02%, based on the amount of dry weight cement.

While association complexes can be formed by using dissolved tin, it is also possible to provide tin in the form of solid tin sulfate particles because these can be partially dissolved to form the association complexes in the aqueous solution but can also be uniformly dispersed as a discontinuous solid particle phase in the aqueous suspension to achieve high loading. The solid tin sulfate particles are believed to be less susceptible to degradation due to the effects of oxygen, and any solubilization of the tin into the water solvent (such as may occur for example during temperature increases) will merely lead to formation of the association complexes to maintain chromium reducing ability of the dissolved the tin ions.

The inventors believe that association complexes suitable for use in the present invention may be taught in certain patents that relate to dentifrice preparations. For example, in U.S. Pat. No. 3,225,076, L. Edwards disclosed a process, which involved mixing an aqueous solution of an acid, selected from the group consisting of gluconic acid and gluconolactone with stannous hydroxide, to obtain an aqueous solution of a compound that he termed “stannogluconic acid.” It is believed that such stannogluconic acid or its salt may function as exemplary association complexes suitable in the present invention for combining with hydratable cement particles or cement clinker to provide storage-stable chromium (VI) reduction to the cement and to cement particles that are interground from the cement clinker. U.S. Pat. No. '076 of Edwards describes that salts of stannogluconic acid may be achieved by reacting stannogluconic acid with a base (Col. 2, II. 12-50), thereby forming an aqueous solution of a salt of the stannogluconic acid.

Hence, other exemplary methods and compositions of the invention involve combining “stannogluconic acid” (and/or the salt form thereof) with cement or cement clinker in order to provide a stabilized chromium (VI) reducer. For purposes of the present invention, it will be understood, unless otherwise expressed, that both acid and salt forms of a particular association complex are intended to be referred to if particular reference is made to an acid or salt form thereof.

The present inventors believe that another exemplary association complex suitable for use in the present invention involves the use of other non-lignosulfonate-based complexing agents comprising a monocarboxylic acid, a dicarboxylic acid, a polyhydroxyalcohol, an aldehydo acid, or a salt thereof.

As an example, U.S. Pat. No. 3,426,051 of Samuel Hoch disclosed stabilized stannous salts, widely used as catalysts in the production of polyurethane resins, stabilized by the addition of small amounts of alkylhydroquinones having an six-carbon aromatic ring structure with two hydroxyl groups and two pendant groups, (OH)₂ØRR′, wherein R represents a C₁-C₆ alkyl group and R′ represents hydrogen or a C₁-C₆ alkyl group. Illustrative of such alkylhydroquinones are the following: toluhydroquinone, ethylhydroquinone, isopropylhydroquinone, tertiarybutylhydroquinone, tertiaryamylhydroquinone, n-hexylhydroquinone, dimethylhydroquinone, di-n-propylhydroquinone, di-tertiarybutylhydroquinone, di-tertiary-amylhydroquinone, dihexylhydroquinone, and mixtures thereof. The present inventors believe that such alkylhydroquinones can function as suitable complexing agents for purposes of the present invention.

U.S. Pat. No. '051 of Hoch also disclosed various stannous salts that can be stabilized by addition of the aforementioned alkylhydroquinones. These include stannous salts of aliphatic monocarboxylic acids having from 6 to 18 carbon atoms and stannous salts of aliphatic dicarboxylic acids having from 4 to 10 carbon atoms, for example, stannous hexoate, stannous 2-ethylhexoate, stannous n-octaoate, stannous decanoate, stannous laurate, stannous hydristate, stannous eleate, stannous succinate, stannous glutarate, stannous adipate, stannous azelate, and stannous sebacate. Hoch mentions that only a small amount of the alkylhydroquinone need be added to the stannous salt to improve its stability; as little as 0.1% based on the weight of the salt will inhibit its oxidation to the stannic form, though it is preferable to use 1.0-1.5% based on weight of the salt of the alkyhydroquinone (Col. 2, II. 32-50). The stabilized stannous salts may be prepared merely by adding the alkyhydroquinone to the salt and stirring until a homogeneous solution is obtained. In some cases, it may be necessary to heat the mixture to effect solution of the alkylhydroquinone.

Hoch mentions that his stabilized stannous salts are compatible with tertiary amines (col. 2, II. 50-51), so the present inventors believe that a combination of such stabilized stannous salts with a tertiary amine, such as triisopropanolamine, triethanolamine, or mixture thereof, are exemplary cement additives of the invention that may be combined with Hoch's stabilized stannous salts as a premixed cement additive for use in the intergrinding of cement from clinker.

Exemplary liquid compositions of the invention may employ one or more viscosity modifying agents (VMA) to achieve high levels of solid particle suspensions. In other words, when a VMA is incorporated into the aqueous liquid carrier, this allows a large amount of solid tin sulfate particles to be dispersed within the aqueous liquid carrier. A preferred VMA is xanthan gum. Other VMAs suitable for use in the present invention are disclosed in U.S. Ser. No. 10/890,476 of Jardine published on May 26, 2005 (Publication No. US2005-0109243 A1). For purposes of the present invention, the use of a VMA is optional and not necessarily preferred, since the use of the complexing agent increases the effectiveness of the chromium reducer at whatever loading level is desired, and particularly in the water-soluble state.

In addition to stannous sulfate and ferrous sulfate, other water-soluble salt forms of these metals may be employed as a chromium (VI) reducer, such as chloride, bromide, acetate, oxide, and sulfide salts, as well as tin hydroxide. Preferably, the metal should be employed in amounts of at least 20 parts per million (ppm) based on dry weight of the cement per 5 ppm of (water-soluble) chromium (VI), more preferably at least 60 ppm, and most preferably at least 100 ppm based on dry weight of the cement per 5 ppm of chromium (VI).

An exemplary chromate-reducing liquid composition of the invention therefore may comprise stannous (tin II) ions and preferably solid tin salt particles (such as tin sulfate) in the amount of 10 to 80 percent (%) based on total weight of the liquid composition, and more preferably in the amount of 20 to 50%; a non-lignosulfonate-based complexing agent in the amount of 1 to 80%, and more preferably in the amount of 2 to 50%; water as a liquid carrier in the amount of 10 to 80%, and more preferably in the amount of 35 to 70%; and optionally one or more VMAs in the amount of 0.01 to 10%, and more preferably in the amount of 0.2 to 1.0%, all percentages based on total weight of the liquid composition.

A further exemplary method and composition of the invention comprises at least one cement additive, either premixed with the tin ions or added separately, selected from the group consisting of alkanolamines (e.g., triisopropanolamine, triethanolamine), glycols, sugars and chloride salts. The cement additive may be used in an amount of 5% to 80%, and more preferably 5 to 50%, based on total weight of the liquid composition.

Preferred compositions and methods of the invention comprise the use of stannous sulfate and sodium gluconate in an association complex. The molar ratio at which stannous sulfate:sodium gluconate are combined is preferably 4:1 to 1:4, more preferably in a ratio of 2:1 to 1:2, and most preferably in a 1:1 molar ratio.

Without being bound by theory, the present inventors provide the following explanation to underscore what they believe to be the mechanism by which this preferred “stannous sulfate/sodium gluconate association complex” operates in cementitious compositions. Stannous sulfate is the source of stannous ions (Sn^{II}), which are the active agent responsible for reducing chromium (VI) to chromium (III), according to the following equation (1): 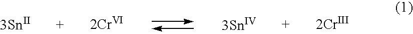
It is believed that sodium gluconate stabilizes the stannous composition during storage and use, because, in the absence of sodium gluconate, the stannous (tin II) chromium reducing agent loses effectiveness over time due to the undesired reaction of the active ingredient, Sn^{II}, with adventitious oxygen in the atmosphere. Sodium gluconate does not reduce chromium (VI) to chromium (III) in the absence of stannous ions.

While the exact mechanism of the protective action of sodium gluconate within the composition is not known, the present inventors believe that sodium gluconate stabilizes the stannous composition by formation of a stannous sulfate/sodium gluconate adduct, or by intimate commingling with and/or coating the stannous sulfate particles when incorporated into cement, or by a combination of these and other mechanisms.

While the exact nature of any adducts formed would be speculation, the inventors have discovered that ¹H, ¹³C, and ¹¹⁹Sn NMR experiments indicate that there is some interaction between SnSO₄ and sodium gluconate as depicted in equation 2 below. The equilibrium concentrations of any of the species in this equilibrium would depend on temperature, pH and the concentrations of individual components of the mixture.
SnSO₄+Sodium Gluconate<=>SnSO₄/Sodium gluconic acid adduct (2)

The NMR spectra upon which the foregoing discussion is based presented in the examples provided herein and attached as drawings.

While the invention is described herein using a limited number of embodiments, these specific embodiments are not intended to limit the scope of the invention as otherwise described and claimed herein. Modification and variations from the described embodiments exist. More specifically, the following examples are given as specific illustrations of embodiments of the claimed invention. The invention is not limited to the specific details set forth in the examples. All parts and percentages in the examples, as well as in the remainder of the specification, are by weight unless otherwise specified.

Further, any range of numbers recited in the specification or claims, such as that representing a particular set of properties, units of measure, conditions, physical states or percentages, is intended to literally incorporate expressly herein by reference or otherwise, any number falling within such range, including any subset of numbers within any range so recited. For example, whenever a numerical range with a lower limit, RL, and an upper limit RU, is disclosed, any number R falling within the range is specifically disclosed. In particular, the following numbers R within the range are specifically disclosed: R=RL+k*(RU−RL), where k is a variable ranging from 1% to 100% with a 1% increment, e.g., k is 1%, 2%, 3%, 4%, 5%. . . . 50%, 51%, 52%, . . . 95%, 96%, 97%, 98%, 99%, or 100%. Moreover, any numerical range represented by any two values of R, as calculated above, is also specifically disclosed.

### EXAMPLE 1

Chromium (VI) reducing agents containing stannous tin are interground into cement at dosages to insure delivery of 100 ppm of stannous sulfate to the cement. The amount of chromium in the cement may be determined by analyzing cement pore water with ultraviolet light (UV) at 375 nanometer (NM) wavelength. The cement is then stored in paper bags for various time periods, and then the chromium content is measured again.

In this case, cement was interground using a premixed stannous sulfate and sodium gluconate mixture (forming the stannous sulfate/sodium gluconate association complex of the invention in aqueous suspension), and this is compared to a case in which cement is interground with the stannous sulfate and sodium gluconate added separately in powder form (and thus not complexed). The stannous sulfate/sodium gluconate association complex had a total solids of 56% (28% stannous sulfate, 28% sodium gluconate), such that 100 parts per million (“ppm”) of stannous sulfate and 100 ppm of sodium gluconate were delivered to the cement. After the cement and stannous sulfate/sodium gluconate association complex were interground, the chromium content was confirmed as being reduced from 8.0 ppm to 2.5 ppm, a difference of 5.5 ppm. After 84 days, the chromium content was 2.9 ppm, an increase of 0.4 ppm. After 56 days, the chromium content remained at 2.5 ppm. At 26 days, the chromium content was 3.4 ppm, which represents an increase of 0.9 ppm.

When cement was interground using stannous sulfate and sodium gluconate added separately in powder form (and thus not complexed), it was found that chromium content was reduced from 11.8 ppm to 4.5 ppm, or a reduction of 7.3 ppm. After 56 days, chromium content was 6.8 ppm, representing an increase of 2.3 ppm. At 26 days, the chromium content was 7.6 ppm, representing an increase of 3.1 ppm.

Thus, it was confirmed that when cement is interground using premixed stannous sulfate/sodium gluconate association complex of the invention, the chromium content was found to be more stable over time compared to the separate components that were not premixed and complexed.

The results are summarized below in Table 1.

TABLE 1

| | Chromium (Cr) level | | Cr in cement | Cr in cement | Cr in cement |
|---|---|---|---|---|---|
| Additive interground | prior to addition | Cr fresh | stored 26 | stored 56 | stored 84 |
| with cement | (ppm) | cement | days in bags | days in bags | days in bags |
| Stannous sulfate (28%)/ | 8.0 | 2.5 | 3.4 | 2.5 | 2.9 |
| sodium gluconate (28%) | | | | | |
| association complex | | | | | |
| Powders of stannous | 11.8 | 4.5 | 7.6 | 6.8 | N.A. |
| sulfate and sodium | | | | | |
| gluconate added | | | | | |
| separately (not complexed) | | | | | |

### EXAMPLE 2

In this example, a cement is interground with premixed stannous sulfate/sodium gluconate association complex of the invention in aqueous suspension, and the chromium (VI) content of this product is compared to cement that is interground using a 56% stannous sulfate suspension (not complexed). In both cases, 100 ppm of stannous sulfate is added to cement, and in the former case (involving the association complex in aqueous suspension) 100 ppm of sodium gluconate is also delivered to the cement.

The chromium (VI) content of cement interground with the association complex was found to be reduced 8.0 ppm to 2.5 ppm, representing a decrease of 5.5 ppm. After 84 days, the chromium (VI) content was 2.9 ppm, an increase of 0.4 ppm; after 56 days, chromium content remained at 2.5 ppm; and, after 26 days, chromium content was 3.4 ppm, representing an increase of 0.9 ppm.

The chromium (VI) content of the cement interground with the tin sulfate-only suspension was found to be reduced from 8.0 ppm to 2.6 ppm, representing a decrease of 5.4 ppm. After 84 days, chromium content was found to be 4.6 ppm, representing an increase of 2.0 ppm; after 56 days, chromium content was found to be 5.1 ppm, representing an increase of 2.5 ppm; and, after 26 days, the chromium content was 5.3 ppm, representing an increase of 2.7 ppm. It is observed that measured chromium increases over 26, 56, and 84 days, respectively, were 2.7, 2.5, and 2.0, and thus were not linear over time. Also included is an example of an untreated cement that was measured for chromium (VI) levels at 26, 56, and 84 days. The chromium level naturally increased at 26 days from 8.0 to 9.5, and then decreased to 7.1 at 56 days, and then decreased further to a low of 5.2 by 84 days. As the cement ages, less chromium (VI) may naturally become solubilized.

When the tin sulfate-only suspension was used with a different cement clinker having a higher initial chromium (VI) content, the chromium (VI) content was found to be reduced from 11.8 ppm to 0.7 ppm, representing a decrease of 11.1 ppm. After 84 days, chromium content was found to be 4.2 ppm, representing a change of 3.5 ppm. After 56 days, chromium content was found to be 4.8 ppm, representing a change of 4.1 ppm.

Thus, it was confirmed that when cement is interground using a premixed stannous sulfate/sodium gluconate association complex of the present invention in aqueous suspension, the chromium (VI) content was much more stable than in the case in which tin sulfate was used alone in the suspension without the sodium gluconate.

The results are summarized in Table 2 below.

TABLE 2

| | Chromium (VI) level | | Cr (VI) in cement | Cr (VI) in cement | Cr (VI) in cement |
|---|---|---|---|---|---|
| Additive interground | prior to addition | Cr (VI) | stored 26 | stored 56 | stored 84 |
| with cement | (ppm) | fresh cement | days in bags | days in bags | days in bags |
| Stannous Sulfate (28%) and | 8.0 | 2.5 | 3.4 | 2.5 | 2.9 |
| Sodium Gluconate (28%) | | | | | |
| association complex | | | | | |
| Suspension with | 8.0 | 2.6 | 5.3 | 5.1 | 4.6 |
| 56% tin sulfate | | | | | |
| (not complexed) | | | | | |
| Suspension with | 11.8 | 0.7 | 4.5 | 4.8 | 4.2 |
| 56% tin sulfate | | | | | |
| (not complexed) | | | | | |
| Example of untreated | 8.0 | 8.0 | 9.5 | 7.1 | 5.2 |
| cement | | | | | |

### EXAMPLE 3

In this example, a cement that is interground with an aqueous suspension, containing the premixed stannous sulfate/sodium gluconate association complex of the invention, is compared to cement that is interground with tin sulfate powder alone (and thus not having the association complex).

In both cases, 100 ppm of tin sulfate is added to the cement, and, in the case of the premixed suspension having the association complex, 100 ppm of sodium gluconate is also delivered to the cement.

In cement interground with the stannous sulfate/sodium gluconate association complex (formed in aqueous suspension), the chromium (VI) content was reduced from 8.0 ppm to 2.5 ppm, representing a decrease of 5.5 ppm. After 84 days, the chromium content was 2.9 ppm, an increase of 0.4 ppm; after 56 days, chromium content remained at 2.5 ppm; and, after 26 days, chromium content was 3.4 ppm, representing an increase of 0.9 ppm.

In cement interground with tin sulfate powder (and not forming an association complex), the chromium (VI) content was reduced from 8.0 ppm to 1.3 ppm, representing a decrease of 6.7 ppm. After 84 days, chromium content was 4.6 ppm, representing an increase of 3.3 ppm; and, after 56 days, chromium content was 5.8 ppm, representing an increase of 4.5 ppm.

When the cement interground with tin sulfate powder was tested a second time, the chromium (VI) content was reduced from 11.8 ppm to 3.6 ppm, representing a decrease of 8.2 ppm. After 84 days, chromium content was found to be 6.9 ppm, representing an increase of 3.3 ppm; and, after 56 days, chromium content was 7.6 ppm, representing an increase of 4 ppm.

The test confirmed that chromium (VI) content in the cement interground with the premixed stannous sulfate/sodium gluconate association complex of the present invention was much more stable than the chromium content of the cement that was interground with tin sulfate powder alone (no association complex).

The results are summarized in Table 3 below.

TABLE 3

| | Chromium (Cr) level | | Cr in cement | Cr in cement | Cr in cement |
|---|---|---|---|---|---|
| Additive interground | prior to addition | Cr fresh | stored 26 | stored 56 | stored 84 |
| with cement | (ppm) | cement | days in bags | days in bags | days in bags |
| Stannous Sulfate (28%) and | 8.0 | 2.5 | 3.4 | 2.5 | 2.9 |
| Sodium Gluconate (28%) | | | | | |
| association complex | | | | | |
| Tin sulfate powder | 8.0 | 1.3 | 4.7 | 5.8 | 4.6 |
| (not complexed) | | | | | |
| Tin sulfate powder | 11.8 | 3.6 | 6.8 | 7.6 | 6.9 |
| (not complexed) | | | | | |

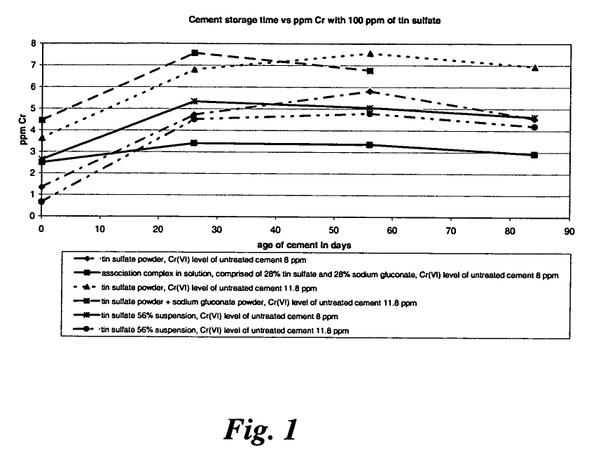

The data for Examples 1 through 3 above are shown graphically in FIG. 1

### EXAMPLE 4

Chromium reducing agents containing stannous tin were interground into cement at dosages to insure delivery of 150 ppm of tin sulfate to cement. As mentioned in Example 1, the chromium content of the cement is measured by measuring UV of cement pore water at 375 NM. The cement was stored in paper bags for various periods of time, and then chromium content was again measured.

In this example, the chromium (VI) content of cement that is interground with a premixed aqueous solution containing the stannous sulfate/sodium gluconate association complex of the present invention is compared to the chromium content of cement that is interground with tin sulfate and sodium gluconate added separately as powders (and thus not presented in an association complex as taught by the present invention).

The premixed suspension having the association complex had a total solids of 56% (28% stannous sulfate, 28% sodium gluconate). In both cases, 150 ppm of stannous sulfate and 150 ppm of sodium gluconate were combined with cement.

In the cement sample that was interground with the premixed suspension having the association complex, chromium (VI) content is found to be reduced from 8.0 ppm to 0 ppm. After 84 days, chromium content was found to be 1.2 ppm; and, after 56 days, chromium content was found to be 0.16 ppm.

In the cement sample that was interground with the tin sulfate and sodium gluconate powders added separately (and thus not in an association complex), the chromium (VI) content was reduced from 11.8 ppm to 0.3 ppm, representing a difference of 11.5 ppm. After 84 days, the chromium content was 5.1 ppm, representing an increase of 4.8 ppm; and, after 56 days, the chromium content was 5.8 ppm, representing an increase of 5.5 ppm.

The data confirmed that cement interground with the premixed aqueous suspension having the stannous sulfate/sodium gluconate association complex of the present invention performed better in lowering chromium (VI) content, and appeared to confirm that the association complex stabilized the stannous sulfate and rendered it more effective in reducing chromium (VI) levels in the cement.

The data is summarized in Table 4 below.

TABLE 4

| | Chromium (Cr) level | | Cr in cement | Cr in cement | Cr in cement |
|---|---|---|---|---|---|
| Additive interground | prior to addition | Cr fresh | stored 26 | stored 56 | stored 84 |
| with cement | (ppm) | cement | days in bags | days in bags | days in bags |
| Stannous Sulfate (28%) and | 8.0 | 0 | | 0.16 | 1.2 |
| Sodium Gluconate (28%) | | | | | |
| association complex | | | | | |
| Tin sulfate powder and | 11.8 | 0.3 | 4.2 | 5.8 | 5.1 |
| sodium gluconate powder | | | | | |
| (not complexed) | | | | | |

### EXAMPLE 5

In this example, the chromium (VI) content of a cement that is interground with a premixed aqueous suspension in which was formed the stannous sulfate/sodium gluconate association complex of the present invention is compared to the chromium (VI) content of a cement interground with a 56% tin sulfate suspension. In each case, 150 ppm of tin sulfate is added to the cement. In the sample containing the premixed aqueous suspension wherein the stannous sulfate/sodium gluconate assocation complex is formed, 150 ppm of sodium gluconate is delivered to the cement.

The chromium (VI) content of cement interground with the stannous sulfate/sodium gluconate association complex in the premixed aqueous suspension was reduced from 8.0 ppm to 0 ppm. After 84 days, the chromium content was found to be 1.2 ppm; and, after 56 days, chromium content was found to be 0.16 ppm.

The chromium (VI) content of the cement interground with the tin sulfate-only suspension (not complexed) was reduced from 8.0 ppm to 1.4 ppm, representing a difference of 6.6 ppm. After 84 days, the chromium content was 4.5 ppm, representing an increase of 3.1 ppm; and, after 56 days, the chromium content was 5.4 ppm, representing an increase of 4 ppm.

The chromium (VI) content of cement that was interground with the premixed aqueous suspension wherein the stannous sulfate/sodium gluconate assocation complex of the present invention was formed was found to be more stable than the chromium (VI) content of cement interground with only tin sulfate.

The data is summarized in Table 5 below.

TABLE 5

| | Chromium (Cr) level | | Cr in cement | Cr in cement | Cr in cement |
|---|---|---|---|---|---|
| Additive interground | prior to addition | Cr fresh | stored 26 | stored 56 | stored 84 |
| with cement | (ppm) | cement | days in bags | days in bags | days in bags |
| Stannous Sulfate (28%) and | 8.0 | 0 | | 0.16 | 1.2 |
| Sodium Gluconate (28%) | | | | | |
| association complex | | | | | |
| Suspension containing | 8.0 | 1.4 | 5.5 | 5.4 | 4.5 |
| only tin sulfate (56%) | | | | | |
| (not complexed) | | | | | |

### EXAMPLE 6

In this example, the chromium (VI) content of cement interground with a premixed aqueous suspension of stannous sulfate/sodium gluconate association complex of the present invention is compared to the chromium (VI) content of cement interground with tin sulfate powder (alone and not complexed). In each case, 150 ppm of tin sulfate is added to cement. In the case of the premixed suspension containing the stannous sulfate and sodium gluconate association complex of the invention, 150 ppm of sodium gluconate is also delivered to the cement.

The chromium (VI) content of cement interground with the premixed aqueous suspension of stannous sulfate/sodium gluconate association complex was reduced from 8.0 ppm to 0 ppm. After 84 days, chromium content was found to be 1.2 ppm; and, after 56 days, chromium content was found to be 0.16 ppm.

The chromium (VI) content of cement interground with tin sulfate powder alone (and not complexed) was reduced from 8.0 ppm to 0 ppm. After 84 days, chromium content was increased to 4.3 ppm; and, after 56 days, chromium content was increased to 4.6 ppm.

The chromium (VI) content of a second sample of cement interground with the tin sulfate powder was found to be reduced from 11.8 ppm to 0 ppm. After 84 days, chromium content was 6.9 ppm; and, after 56 days, chromium content was 4.5 ppm, representing an increase of 4.5 ppm.

The data confirmed that chromium (VI) content in cement interground with the premixed aqueous suspension in which was formed the stannous sulfate/sodium gluconate association complex of the present invention was more effective in reducing the chromium (VI) content in cement interground when compared to tin sulfate powder alone (not complexed).

The data is summarized in Table 6 below.

TABLE 6

| | Chromium (VI) level | | Cr (VI) in cement | Cr (VI) in cement | Cr (VI) in cement |
|---|---|---|---|---|---|
| Additive interground | prior to addition | Cr (VI) | stored 26 | stored 56 | stored 84 |
| with cement | (ppm) | fresh cement | days in bags | days in bags | days in bags |
| Stannous Sulfate (28%) and | 8.0 | | 0 | 1.6 | 1.2 |
| Sodium Gluconate (28%) | | | | | |
| association complex | | | | | |
| tin sulfate powder | 8.0 | 0.0 | 2.0 | 4.6 | 4.3 |
| (not complexed) | | | | | |
| tin sulfate powder | 8.0 | 0.0 | 3.7 | 4.5 | 6.9 |
| (not complexed) | | | | | |

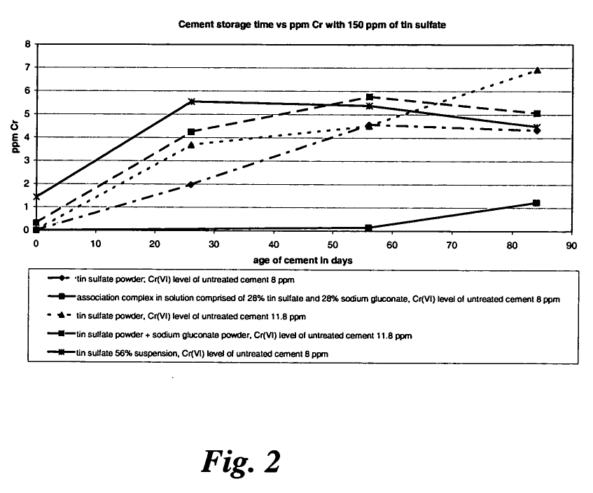

The data for examples 4 through 6 are illustrated in FIG. 2.

### EXAMPLE 7

An exemplary composition of the invention, containing the stannous sulfate/sodium gluconate association complex formed in a premixed aqueous suspension, operative for maintaining storage stability of chromium (VI) reducer, is made as follows. 43.3 parts of water are added to a mixing vessel. 14 parts of tin sulfate are dispersed or dissolved in this water. Next, 0.68 parts of a xanthan gum are added to thicken the dispersion (the use of this gum as a viscosity modifying agent is believed to be optional). After the dispersion has visibly thickened, an additional 14 parts of tin sulfate are dispersed into the mixture. Then 28 parts of sodium gluconate are dispersed in the mixture. Final product viscosity is 13000-16000, measuring at 6 rpm on a Brookfield viscometer (spindle #4). Final product specific gravity is 1.50-1.80. Final product pH is 0.5-2.0.

### EXAMPLE 8

Another exemplary composition for use in maintaining the storage stability of chromium (VI) reducer in cement or cement clinker is made as follows. 30 parts of water are added to a mixing vessel. 35 parts of sodium gluconate are dissolved in this water. 35 parts of tin sulfate are added to this water. Viscosity is 225 cps (6 rpm on a Brookfield viscometer, spindle #4). Specific gravity is 1.64. Final product pH is 0.5-2.0.

### EXAMPLE 9

Another exemplary composition, containing stannous sulfate/sodium gluconate association complex of the invention in a premixed aqueous suspension, operative for maintaining storage stability of chromium (VI) reducer, is made as follows: 43.3 parts of water are added to a mixing vessel; 14 parts of tin sulfate are dispersed or dissolved in this water; next, 0.6 parts of a xanthan gum is added to thicken the dispersion; and, after the dispersion has visibly thickened, an additional 23.3 parts of tin sulfate are dispersed in the mixture. Then 18.7 parts of sodium gluconate are dispersed in the mixture. Final product viscosity is 10,000-14,000 (measured at 6 rpm on a Brookfield viscometer, spindle #4). Final product specific gravity is 1.50-1.80. Final product pH is 0.5-2.0.

### EXAMPLE 10

An industrial cement is interground with a stannous sulfate/sodium gluconate association complex of the present invention, and the chromium (VI) content of this product is compared to cement that is interground using a 56% tin sulfate suspension (not having the association complex). In both cases, various amounts of tin sulfate are added to cement, and in the former case (involving the association complex in aqueous suspension) an equal amount of sodium gluconate is also delivered to the cement. Cement was then stored and chromium content was re-measured at various time intervals up to 84 days.

After 84 days of storage, the stannous tin delivered in the form of the association complex was more effective in reducing Chromium (VI) levels than was the stannous tin alone delivered in the form of a stannous sulfate suspension. For example, cement with 75 or 95 ppm of stannous tin delivered in the form of the association complex had a Cr(VI) content of 3.2 or 1.4 ppm. Cement with 77 or 92 ppm of stannous tin delivered in the form of the stannous sulfate suspension had a Cr(VI) content of 8.4 or 8.2 ppm.

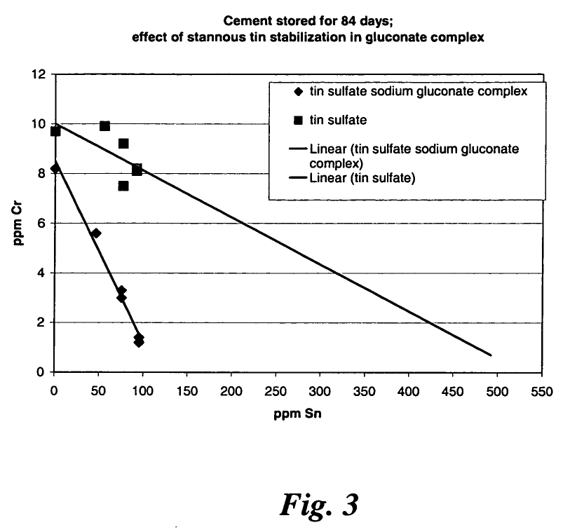

The chromium (IV) content of the cement interground with a stannous sulfate/sodium gluconate association complex of the present invention was measured, and the data shown in Table 7 below, while the chromium (VI) content of cement interground using a 56% tin sulfate suspension (tin sulfate alone) is shown in Table 8 below and graphically illustrated in FIG. 3.

TABLE 7
Stannous Sulfate/Sodium Gluconate Association Complex

| | | | | Age in days | | | |
|---|---|---|---|---|---|---|---|
| Parts per | ppm | | | 0 | 28 | 56 | 84 |
| million | pro- | ppm tin | ppm | ppm | ppm | ppm | ppm |
| (ppm) | duct | sulfate | Sn(II) | Cr(VI) | Cr(VI) | Cr(VI) | Cr(VI) |
| | 0 | | 0 | 9.8 | 10.1 | 8.9 | 8.2 |
| | 300 | 84 | 46 | 4.6 | 5.1 | 5.0 | 5.6 |
| | 490 | 137 | 75 | 1.9 | 2.8 | 3.0 | 3.3 |
| | 490 | 137 | 75 | 1.9 | 2.6 | 3.2 | 3.0 |
| | 620 | 174 | 95 | 0.5 | 0.0 | 0.9 | 1.4 |
| | 620 | 174 | 95 | 0.5 | 0.0 | 0.8 | 1.2 |

TABLE 8
Stannous Sulfate (Alone) in Suspension

| | | | | Age in days | | | |
|---|---|---|---|---|---|---|---|
| Parts per | ppm | | | 0 | 28 | 56 | 84 |
| million | pro- | ppm tin | Ppm | ppm | ppm | ppm | ppm |
| (ppm) | duct | sulfate | Sn(II) | Cr(VI) | Cr(VI) | Cr(VI) | Cr(VI) |
| | | | 0.0 | 10.8 | 10.5 | 10.5 | 9.7 |
| | 180 | 101 | 55 | 6.2 | 8.6 | 9.7 | 9.9 |
| | 250 | 140 | 77 | 3.0 | 7.4 | 9.7 | 7.5 |
| | 250 | 140 | 77 | 3.0 | nd | 9.5 | 9.2 |
| | 300 | 168 | 92 | 0.0 | 5.9 | 9.0 | 8.2 |
| | 300 | 168 | 92 | 0.0 | 6.6 | 7.3 | 8.1 |

### EXAMPLE 11

Chromium (VI) reducing agents containing stannous tin are interground into cement at dosages to insure delivery of 28 or 55 ppm of stannous tin to the cement. The amount of chromium (VI) in the cement may be determined by analyzing cement pore water with ultraviolet light (UV) at 375 nanometer (NM) wavelength. The cement is then stored in paper bags for various time periods, and then the chromium (VI) content is measured again.

In this case, cement is interground using a premixed stannous sulfate/sodium gluconate association complex of the present invention formed in an aqueous suspension, and this is compared to cement which is interground with premixed stannous chloride and sodium gluconate (forming another association complex of the present invention).

The stannous sulfate/sodium gluconate association complex was confirmed to have total solids of 56% (28% stannous sulfate, 28% sodium gluconate). The stannous chloride/sodium gluconate association complex was confirmed to contain 21% stannous chloride, 41% sodium gluconate, and 35% water.

Both products reduced the initial Cr (VI) level of the fresh cement, from an untreated level of 8 ppm Cr(VI), as shown in table 9 below.

The chromium (VI) content of cement containing the stannous sulfate/sodium gluconate association complex increased by 0.5 ppm after 60 days of storage with at each dosage. However, the chromium content of cement containing the stannous chloride/sodium gluconate association complex increased by 1.6-1.7 ppm after 60 days of storage.

Thus, the present inventors discovered that when cement is interground using the premixed stannous sulfate/sodium gluconate association complex, the stannous (tin II) component to lower chromium (VI) content was found to be more stable over time compared to the stannous chloride/sodium gluconate association complex.

Hence, the stannous sulfate/sodium gluconate association complex is most preferred. The results are summarized below in Table 9.

TABLE 9

| | Chromium | | Cr (VI) | Change in |
|---|---|---|---|---|
| | (VI) level | | in cement | Cr (VI) |
| | prior to | Cr (VI) | stored 60 | after |
| Additive interground | addition | fresh | days in | cement |
| with cement | (ppm) | cement | bags | storage |
| Stannous sulfate | 8.0 | 3.7 | 4.2 | +0.5 |
| (28%)/sodium gluconate | | | | |
| (28%) association | | | | |
| complex delivering | | | | |
| 28 ppm Sn(II) | | | | |
| Stannous sulfate | 8.0 | 2.9 | 3.1 | +0.5 |
| (28%)/sodium gluconate | | | | |
| (28%) association | | | | |
| complex delivering | | | | |
| 55 ppm Sn(II) | | | | |
| Stannous chloride/ | 8.0 | 4.8 | 6.4 | +1.6 |
| sodium gluconate | | | | |
| association complex | | | | |
| delivering 28 ppm | | | | |
| Sn(II) | | | | |
| Stannous chloride/ | 8.0 | 1.7 | 3.4 | +1.7 |
| sodium gluconate | | | | |
| association complex | | | | |
| delivering 55 ppm | | | | |
| Sn(II) | | | | |

### EXAMPLE 12

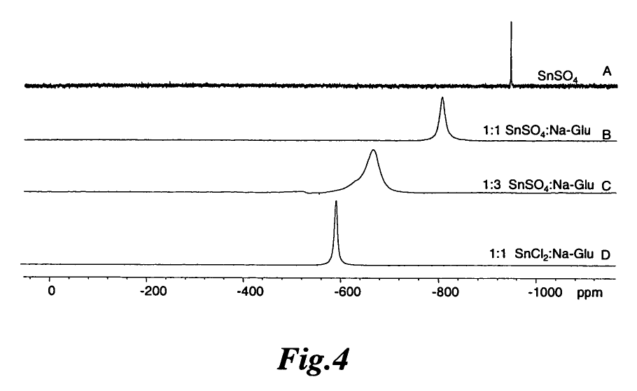

The present inventors made several association complexes in accordance with the present invention, and graphic illustrations of the these assocation complexes in terms of their Nuclear Magnetic Resonance (NMR) Spectra (¹¹⁹Sn NMR, ¹³C NMR, and ¹H NMR are set forth in FIGS. 4 through 7, respectively.

NMR Spectra were acquired on a 9.4 Tesla Varian UNITYINOVA spectrometer operating at 399.8 MHz for ¹H, 100.5 MHz for ¹³C, and 149.1 MHz for ¹¹⁹Sn nuclei. Experiments were conducted without chemical, or physical perturbation of the sample. A capillary insert containing deuterium oxide was used for field frequency lock. Carbon and proton NMR spectra were referenced to an external 10 mM solution of sodium trimethysilylpropionate in D₂O. A 10 mM solution of tetramethyltin in CDCl₃ was used as an external reference standard for ¹¹⁹Sn NMR spectroscopy. All NMR spectra in this report were carried out at the fixed temperature of 27° Celcius.

¹¹⁹Sn NMR spectra of stannous sulfate, as well as mixtures of stannous sulfate or stannous chloride with sodium gluconate, are shown in FIG. 4. Spectrum A shows a single sharp resonance for stannous sulfate (SnSO₄). Addition of one equivalent (spectrum B) or three equivalents (spectrum C) of sodium gluconate cause a broadening of the resonance and a shift to lower field suggesting chemical exchange among two or more transient tin-containing species, such as stannous sulfate and a stannous sulfate/sodium gluconate adduct (association complex). The composition is believed to be undergoing rapid exchange within the NMR timescale (microseconds). This exchange is believed to involve any or all of the ligands associating with the tin ions at the same time: gluconate, sulfate, and water.

Hence, exemplary compositions of the invention comprise a composition wherein a chromium (VI) reducer (e.g., stannous sulfate) is associated with a complexing agent (e.g., sodium gluconate) in an aqueous environment (e.g., a suspension), and the NMR spectrum for the chromium (VI) reducer is broadened when compared to the NMR spectrum for the chromium (VI) reducer alone.

Spectrum D is a 1:1 molar mixture of sodium gluconate with stannous chloride (SnCl₂). In comparison to spectra B and C, the downfield resonance and narrower line width in spectrum D shows that the 1:1 mixture of sodium gluconate and stannous chloride is not undergoing rapid exchanges of associations involving gluconate, chloride, or water.

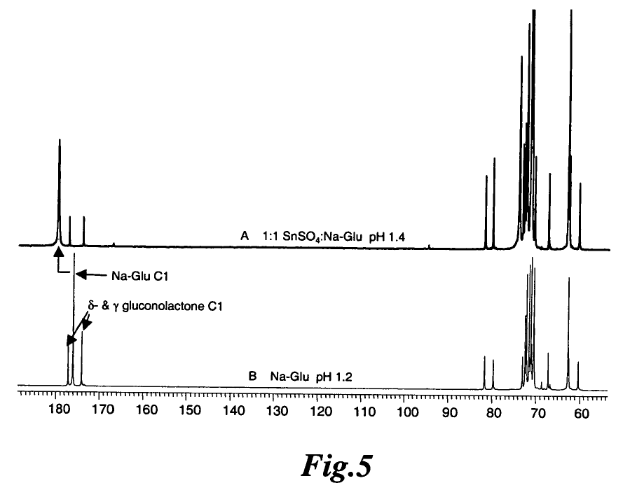

The ¹³C NMR data supports the supposition that the stannous sulfate/sodium gluconate complex is in equilibrium with free sodium gluconate. FIG. 5 is a graphic illustration of ¹³C NMR spectra depicting a downfield shift in the resonance for ¹C of the sodium gluconate composition, indicating changes in the magnetic environment of the ¹C nucleus. The presence and intensity of the ¹C resonances for the d- and g-gluconolactone strongly suggest the presence of free gluconate, and thus free stannous sulfate in the mixture of stannous sulfate/sodium gluconate. If the sodium gluconate were fully coordinated to the stannous sulfate in the mixture, one would expect the lactone peaks to be dramatically reduced or eliminated.

Hence, exemplary compositions of the invention comprise a composition wherein a chromium (VI) reducer (e.g., stannous sulfate) is associated with a carbon-containing complexing agent (e.g., sodium gluconate) in an aqueous environment, and the ¹³C NMR spectrum for ¹C of the complexing agent is shifted downfield when compared to the ¹C spectrum for that of the complexing agent alone.

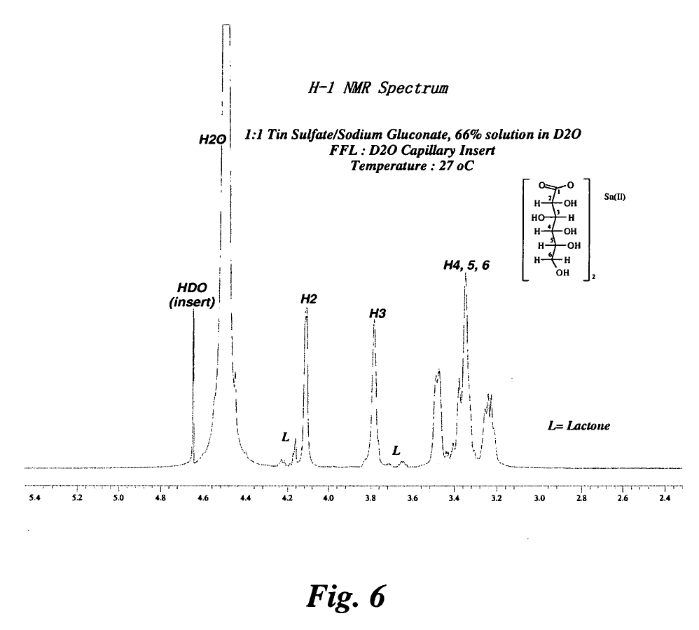

The ¹H NMR data supports the supposition that the stannous sulfate/sodium gluconate association complex of the invention is in equilibrium with free water molecules. FIG. 6 illustrates a broadening of water resonance in terms of the ¹H NMR spectra, suggesting the active association/dissociation of water molecules (H₃O+) with the stannous (tin II) ions.

Hence, exemplary compositions of the invention comprise a composition wherein a chromium (VI) reducer (e.g., stannous sulfate) is associated with a carbon-containing complexing agent (e.g., sodium gluconate) in an aqueous environment, and the ¹H NMR spectrum for ¹C of the complexing agent indicates active association/dissociation of water molecules (H₃O+) with the stannous (tin II) ions.

It is observed that both the 1:1 association complex of stannous sulfate/sodium gluconate and the 1:1 association complex of stannous chloride/sodium gluconate were evaluated in example 11, with the 1:1 stannous sulfate/sodium gluconate association complex exhibiting the most stable and effective performance for reducing chromium (VI) levels.

From this performance data and the NMR data, it can be suggested that the association complex formed by premixing stannous sulfate and sodium gluconate together in an aqueous environment, form a labile, weakly associated adduct (or adducts) of stannous sulfate/sodium gluconic acid, and that free stannous ions and gluconic acid groups may also be present, and this is preferred. On the other hand, the association complex formed by combining stannous chloride and sodium gluconate did not show evidence of equilibrium with free stannous chloride and sodium gluconate, and thus this is less preferred.

The foregoing examples and exemplary embodiments are intended for illustrative purposes only, and not to limit the scope of the invention, as modifications and variations may be envisioned by those of ordinary skill in view of the disclosures contained herein.

We claim:

1. A method comprising: introducing to cement clinker or to hydratable cement particles a composition having therein an association complex formed from a metal-based chromium (VI) reducer and a non-lignosulfonate-based complexing agent.

2. The method of claim 1 wherein said metal-based chromium (VI) reducer, in said association complex, is combined with said cement clinker or to said hydratable cement particles in an amount of 20-2000 parts per million (ppm) of chromium reducer for each 5 ppm of chromium (VI) contained in said cement clinker or hydratable cement particles.

3. The method of claim 2 wherein said association complex is added to cement clinker before or during the intergrinding process used for manufacturing hydratable cement particles from cement clinker, and said clinker is interground to produce hydratable cement particles combined with said chromium (VI) reducer.

4. The method of claim 3 wherein said hydratable cement particles, after combination with said association complex containing said metal-based chromium (VI) reducer but without further addition of a chromium (VI) reducer, have an average level of chromium (VI) which is less than 2 parts per million by weight of cement, during the successive 28 days after said intergrinding.

5. The method of claim 2 wherein said hydratable cement particles, after combination with said association complex containing said metal-based chromium (VI) reducer but without further addition of chromium (VI) reducer, have an average level of chromium VI which is less than 2 parts per million by weight of cement, during the successive 56 days after said intergrinding.

6. The method of claim 2 wherein said hydratable cement particles, after combination with said association complex containing said metal-based chromium (VI) reducer but without further addition of chromium (VI) reducer, have an average level of chromium VI which is less than 2 parts per million by weight of cement, during the successive 84 days after said intergrinding.

7. The method of claim 1 wherein said association complex is introduced to hydratable cement particles, before, during, or after water is introduced to said cement particles to initiate the process of hydration.

8. The method of claim 1 wherein said metal-based chromium (VI) reducer is a metal salt

9. The method of claim 8 wherein said metal salt is formed from chloride, bromide, acetate, oxide, sulfide, hydroxide, or sulfate.

10. The method of claim 1 wherein said chromium (VI) reducer is stannous (tin II) sulfate.

11. The method of claim 1 wherein said chromium (VI) reducer is selected from the group of stannous sulfate, stannous chloride, ferrous sulfate, ferrous chloride, manganese sulfate, and manganese chloride.

12. The method of claim 1 wherein said association complex is stannous gluconate which is formed from combining stannous chloride, stannous sulfate, or mixture thereof with calcium gluconate, sodium gluconate, or mixture thereof.

13. The method of claim 1 wherein said non-lignosulfonate-based complexing agent is a gluconic acid or salt thereof.

14. The method of claim 1 wherein said non-lignosulfonate-based complexing agent is sodium gluconate.

15. The method of claim 1 wherein said non-lignosulfonate-based complexing agent comprises a monocarboxylic acid, dicarboxylic acid, polyhydroxyalcohol, aldehydo acid, or the salt thereof.

16. The method of claim 1 wherein said non-lignosulfonate-based complexing agent is a metal ion chelating agent.

17. The method of claim 1 wherein said non-lignosulfonate-based complexing agent is selected from the group consisting of ethylenediaminetetraacetic acid (EDTA), mitrilotriacetic acid (N(CH₂COOH)₃, and ethyleneglycol-bis(B-aminoethyl ether)-N,N-tetraacetic acid (NOOCCH₂)₂NCH₂CH₂OCH₂CH₂OCH₂CH₂N(CH₂COOH)₂, ethylene glycol, glycerine, glucose, dextrose, sucrose, polyvinyl alcohol, tripolyphosphates, copolymers of vinyl methyl ether, maleic anhydride, N-benzoyl-N-phenylhydroxylamine, acetylacetone, benzoylacetone, dibenzoylmethane, salicylaldehyde, 8-hydroxyhydroquinone, and 8-quinolinol.

18. The method of claim 2 wherein said non-lignosulfonate-based complexing agent is employed in the amount of 0.0005-0.1% based on dry weight of cement being interground.

19. The method of claim 2 wherein said non-lignosulfonate-based complexing agent is employed in the amount of 0.001-0.02% based on dry weight cement being interground.

20. The method of claim 1 wherein said composition is an aqueous liquid.

21. The method of claim 1 further comprising introducing to cement clinker or to hydratable cement particles at least one cement additive.

22. The method of claim 21 wherein said at least one cement additive is selected from the group consisting of triisopropanolamine, triethanolamine, glycols, sugars and chloride salts.

23. A cement composition provided by the method of claim 1.

24. A cement composition comprising hydratable cement particles and a metal-based chromium (VI) reducer introduced to said cement particles in the form of an association complex formed by combining a metal-based chromium (VI) reducer and a non-lignosulfonate-based complexing agent.

25. The composition of claim 24 wherein said cement has an average level of chromium (VI) which is less than 2 parts per million by weight of cement during the successive 26 days after said association complex is combined with said cement.

26. The composition of claim 24 wherein said cement has an average level of chromium (VI) which is less than 2 parts per million by weight of cement during the successive 56 days after said association complex is combined with said cement.

27. The composition of claim 24 wherein said cement has an average level of chromium (VI) which is less than 2 parts per million by weight of cement during the successive 84 days after said association complex is combined with said cement.

28. A method comprising: introducing to cement clinker or to hydratable cement particles a composition comprising stannous gluconic acid or a salt thereof.

29. A composition, comprising: an association complex formed by combining a metal-based chromium (VI) reducer and a non-lignosulfonate-based complexing agent, said association complex being present in an amount no less than 10% based on total weight of said composition.

30. The composition of claim 1 wherein said association complex is formed by combining, in an aqueous environment, stannous sulfate and sodium gluconate in a molar ratio of 1:2 to 2:1.

31. The composition of claim 1 wherein said association complex is formed by combining, in an aqueous liquid environment, stannous sulfate and sodium gluconate in a molar ratio of 1:1, said association complex comprising at least 20% of said liquid environment by total weight.

32. The composition of claim 1 wherein said association complex is formed by combining stannous sulfate and sodium gluconate in a 1:1 molar ratio, said complex having a ¹³C NMR spectrum, when compared to sodium gluconate alone, as follows: [chemical structure]
